(19) United States
(12) Patent Application Publication
(10) Pub. No.: US 2007/0156394 A1
(43) Pub. Date: Jul. 5, 2007

(54) Method of data entry for indic languages

(76) Inventors: Aroop Kumar Banerjee, Singapore (SG); Aparup Banerjee, Singapore (SG)

Correspondence Address: BANERJEE AROOP KUMAR, 32 JALAN KELABU ASAP, SINGAPORE, 278225, SG

(21) Appl. No.: 10/584,724

(22) PCT Filed: Jan. 14, 2004
(86) PCT No.: PCT/SG04/00013

§ 371 Date: Jun. 27, 2006

(51) Int. Cl. G06F 17/21

(52) U.S. Cl. 704/10

(57) ABSTRACT

An Indic text entry program is proposed which runs on a computer system simultaneously with application software adapted to receive Indic text. The Indic text entry program provides a graphical user interface on a screen of the computer system. A user selects successive Indic characters using a mouse. The successively selected characters are presented in the graphical user interface until, in response to a command from the user, the characters are transferred to the application software. Thus, Indic text can be input to the application software without use of a specially adapted keyboard. The program at each time suggests items from a dictionary consistent with the characters selected so far. If one of the suggestions matches what the user wished to type, the user can select that item rather than typing the rest of the word.

### FIELD OF THE INVENTION

The present invention relates to methods for inputting text written in an Indic language into a computer apparatus.

### BACKGROUND OF INVENTION

The Indic group of languages includes Bengali, Hindi, Tamil, Punjabi, Gurmukhi, Gujarati and others, all of which are historically descended from Sanskrit. One unambiguous definition of the term “Indic language” is languages which are written using the Indic fonts defined by Unicode version 4.0.

Conventionally, when text written in an Indic language is to be entered into a computer system it is done using a keyboard having keys for respective Indic characters. The number of Indic characters is rather higher than in English, however, so such keyboards tend to be difficult to use. This is particularly true because of a peculiarity of Indic languages, that 2 characters may be joined together to form one. Furthermore, “vowel modifiers” may be required to be attached to characters in order to form a word properly. This has discouraged many people, including people who can only write in Indic text, from using an Indic language as a means to communicating using computer systems, such as via chat or by producing documents.

Furthermore, such keyboards are not common in countries where Indic languages are not in common use.

Also, a writer who wishes to write script in both English and an Indic language is required to employ two keyboards. Apart from the expense of providing two keyboards, switching between them as required is inconvenient.

### SUMMARY OF THE INVENTION

The present invention aims to provide a new and useful technique for entering Indic language text into a computer system.

In general terms, the invention proposes an Indic text entry program which runs on a computer system simultaneously with application software adapted to receive Indic text. The Indic text entry program provides a graphical user interface on a screen of the computer system. A user selects successive Indic characters using a data input device (such as a mouse) which employs the graphical user interface. The successively selected characters are presented in the graphical user interface until, in response to a command from the user, the characters are transferred to the application software.

Thus, Indic text can be input to the application software without use of a specially adapted keyboard (or indeed any keyboard at all). Optionally, the computer system can however be provided with a keyboard, for example a Roman alphabet keyboard, for inputting additional text into the application software (e.g. text in English).

Preferably, the graphical user interface presents the user with a number of first characters. Upon selecting one of the first characters, the text entry program presents the user with a number of modifier characters compatible with the first character. Upon the user selecting one of the modifier characters, the text entry program forms the combination of the first character with the modifier characters.

The application software adapted to receive the Indic text may for example be conventional software such as Wordpad, Microsoft Word, Notepad, or Hotmail Messenger. Furthermore, it may be any software which is adapted to receive Unicode characters, such as characters according to the Unicode 4.0 standard. However, other embodiments are possible in which the Indic text entry program and the application software are supplied together as a single commercial software product, providing a first screen area for receiving Indic text and a separate screen area which is used for selecting the Indic characters as described above.

The text entry program and application software both run on the computer system in the same operating system. Preferably, this operating system is Windows, in one of its various editions, such as Windows 2000, or Windows XP supporting Unicode.

Preferably, as the characters are successively input the text entry program compares the previously selected characters to a dictionary of items (words and perhaps also phrases), and presents to the user one or more items from the dictionary which are compatible with the selected characters. The user is able to select one of the presented item, thus saving him or her the labour of completing the entry of all characters of the item he or she was intending to type.

In cases when there are multiple items in the dictionary which are compatible with the selected letters (in particular a number of items which is too large for them all to be displayed in a region of the graphical user interface reserved for displaying these compatible items), the text entry program may present only a selection of them to the user. This subset may be selected based on a frequency index associated with each item, such that the user is presented with the compatible items having the highest frequency. Similarly, the text entry program may order the items which it presents to the user according to the frequency index, e.g. such that the item having the highest frequency index is top of the list.

The user may be able to vary the selection of items shown to him. For example the interface may include a scroll bar, such that by “moving” the scroll bar (e.g. using the mouse), a different set of compatible elements may be displayed in the interface.

### BRIEF DESCRIPTION OF THE FIGURES

Preferred features of the invention will now be described, for the sake of illustration only, with reference to the following figures in which:

FIG. 1 shows the screen in an embodiment of the invention for the Indic language Bengali;

FIG. 2 shows the graphical user interface of the text entry program of the embodiment at a moment in the text selection process;

FIG. 3 is a flow diagram of the operation of the embodiment;

FIGS. 4 to 7 show how the graphical user interface of FIG. 2 is modified in the case of different Indic languages.

### DETAILED DESCRIPTION OF THE EMBODIMENTS

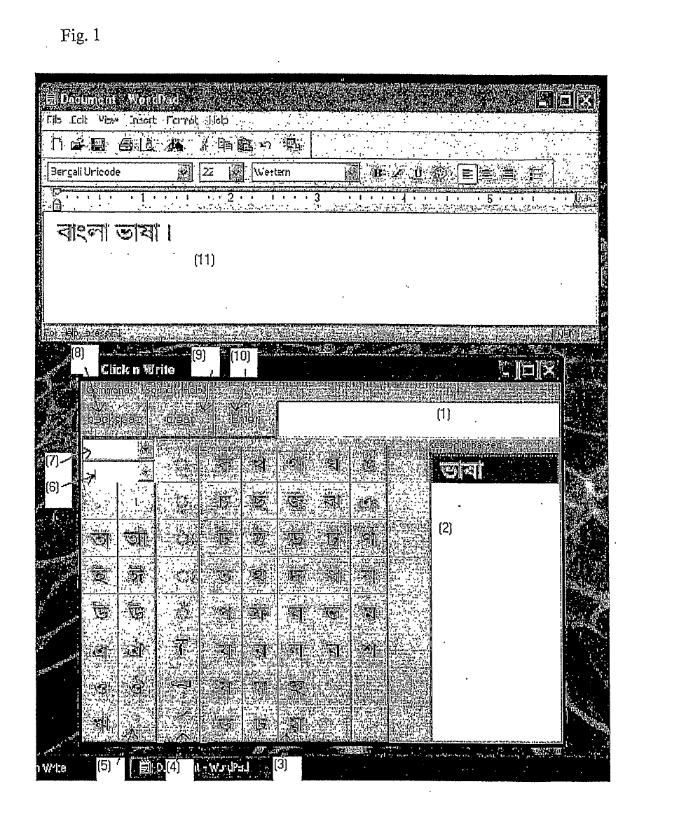

The embodiment of the invention may be a conventional computer system, such as a personal computer (PC). Referring to FIG. 1, the screen of the PC is shown. It has a first window, at the top of the screen, which is a conventional software application (WordPad is shown) capable of receiving Indic text in an area labelled 11. Simultaneously, the computer is running a text entry program which presents a graphical user interface which is the window headed “Click n Write”. This window is suitable for use in the case of entering text in Bengali

The “Click n Write” window includes a section 1 for displaying one or more characters selected by a user. It also includes a section 2 for displaying items from a dictionary of Indic words (and optionally also phrases) consistent with the characters displayed in section 1.

The area of the “Click n Write” window to the left of the section 2 includes a section 3 displaying Indic consonants, a section 4 displaying various signs, and a section 5 displaying Indic vowels. The user can select one of the symbols in the sections 3, 4, 5 by moving an arrow operated by a mouse over the symbol and left-clicking.

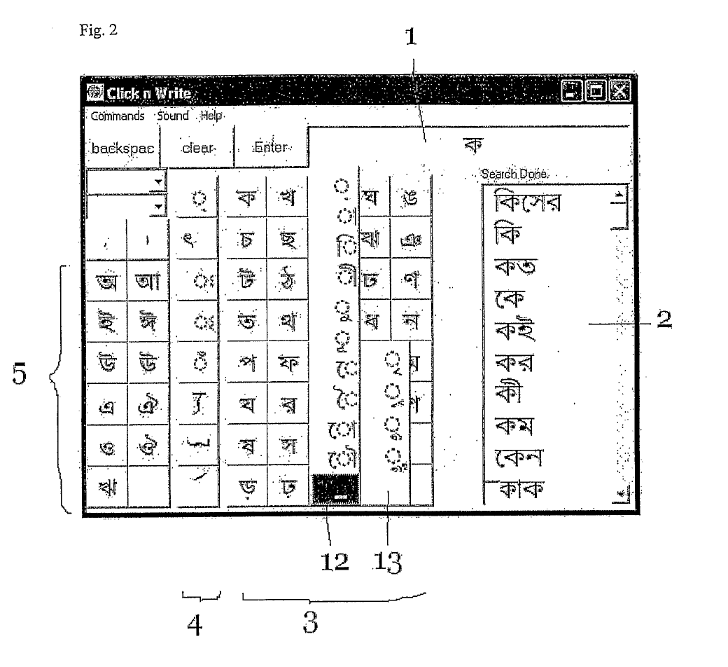

Suppose for example that the user moves the arrow over the consonant at the top left of the section 3 and left-clicks to select it, the display then is as shown in FIG. 2. In section 2 a list is shown of items in the dictionary (i.e. beginning with the selected consonant). These items are selected from a dictionary of items consistent with the selection of characters the user has made, and include also items beginning with the selected character combined with a modifier character. Each item in the dictionary is associated with a frequency index, and of all items in the dictionary consistent with the selected character(s) in section 1, the ones are presented having the highest value of this index. Optionally, they are presented in section 2 in descending order of this index.

Also, upon the user left clicking on the consonant at the top left of section 3, the graphical user interface displays a column of symbols indicated in the column 12, which is mainly a list of modifiers for the selected consonant. The user can select any of these modifiers by left clicking on it. The final item in the column 12 (“---”) is such that if a user moves the arrow over this character a second set of vowel modifiers 13 is displayed, and the user can select one of these by clicking on it. Once a vowel modifier is selected, the list of suggestions in section 2 is changed and section 1 now displays the selected consonant as modified by the selected vowel modifier. Note that, according to the convention of Indic languages, the consonant is often modified by the modifier appearing to the left of the consonant it modifies. If instead of these selections, or following these selections, the user clicks on one of the items in region 2, that item is transferred to the section 1.

The user may then repeat these steps to successively add further characters to the section 1.

Referring again to FIG. 1, if the user clicks on button 8, the last character entered into section 1 is deleted. If the user clicks on button 9, the characters entered in the section 1 are all deleted. If the user clicks on “enter” button 10, the contents of the section 1 are transferred to the area 11. Normally, the area 11 includes a cursor, and the text is transferred to the location indicated by the cursor.

The user can select numerals by selecting from a first drop down menu 7, and can select certain other pre-specified additions (e.g. punctuation characters) from a second drop down menu 6. Optionally, these characters, once selected using the menus 6, 7, may be transferred to the area 11 without the user issuing a separate command.

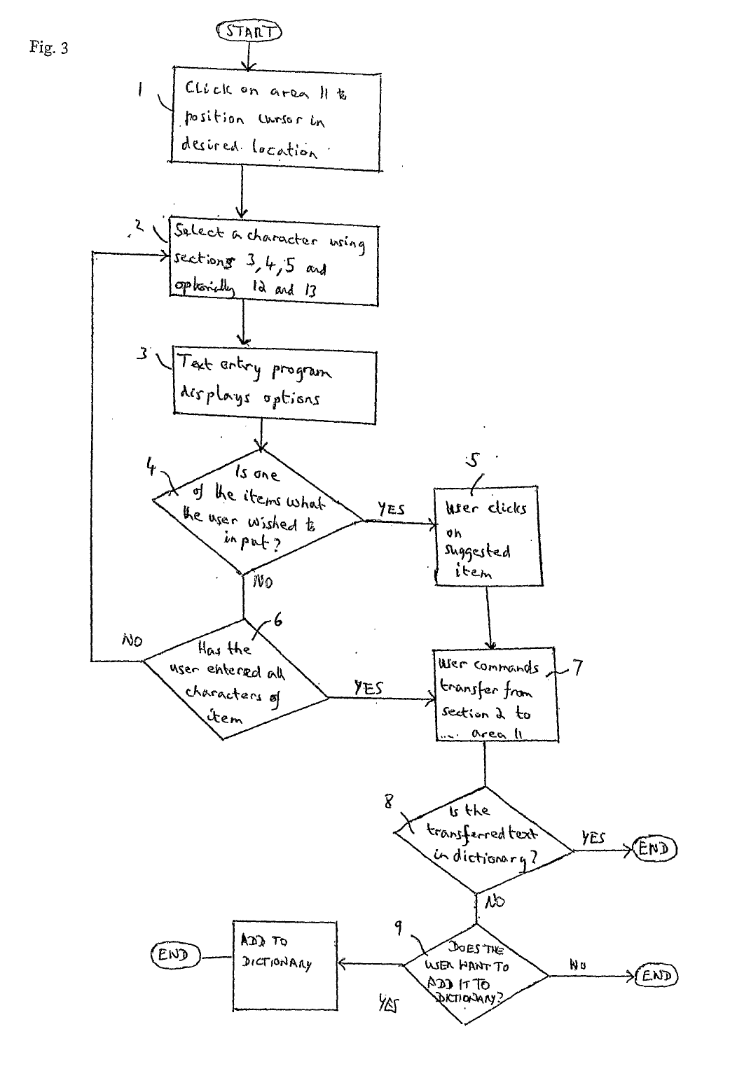

Referring to FIG. 3, the flow diagram of the embodiment is shown showing how a user generates an item and transfers it to the area 11. These steps are performed at a time when the application software and the Indic text entry program are both running.

In step 1, the user clicks on a location within an area 11 of the window of the application software to indicate a location where text is to be added.

In step 2, the user selects a first character using the sections 3, 4, 5 (and, in the case that the user selects a consonant from section 5, optionally using the column 12, and possibly also 13 to select modifiers for the character).

In step 3, the Indic text entry program displays in section 2 a number of items consistent with the selected characters, and the user determines whether one of those items is what he or she intended to type (step 4). If so, then in step 5 he selects that item by clicking on it. It is then displayed in section 1 of the “Click n Write” window. In step 7, the user issues a command, e.g. clicking on the enter button 10 or a right-click on the mouse, to send the selection to the cursor position in the area 11.

If however, the item the user intended to type is not one of the suggestions in section 2, then if there are not characters to be entered (i.e. option “no” in choice 6) the program loops back to step 3 in which the user selects a further character. The text entry program then presents a further list of possible items in the section 2. If one of these is the item the user wanted to type, he selects it by clicking on the item in the section 2 (step 4). Otherwise, he may select a further character, i.e. the flow loops back again from choice 6 to step 3.

If, following any step 2, the user has reached the end of the item he was trying to type (e.g. because it is absent from the dictionary) then he can click on the button 10 or right click to transfer the text at once to the area 11 (i.e. the choice “YES” in step 6. That is, he can jump to step 7.

In step 8 the text entry program checks whether the text being transferred is not in the dictionary. If so, the process ends. If not, in step 9 the text entry program will suggest that it is entered there (e.g. by generating a text box with clickable areas marked “yes” and “no”). If the user decides not, the process ends. If the user decides to enter the item in the dictionary (e.g. clicks on “yes”) it is added there, step 10, and the process ends.

Note that the “END” of the process in FIG. 3 means that the user has successfully generated an item in the area 11. If this is not the end of the text the user wanted to input, the process of FIG. 3 begins again. That is, by default, the END of FIG. 3 is followed by a return to step 1, for the generation of a further item.

Although only a single embodiment of the invention has been described, many variations are possible within the scope of the invention as will be clear to a skilled reader. For example the flow diagram of FIG. 3 can be modified in various ways, such as by having the flow move from step 5 to step 6, such that the user is able to add one or more further characters to the item in section 1 selected from the dictionary, or modify it by deleting and/or adding characters, before issuing the command to transfer the text from section 1 to area 11.

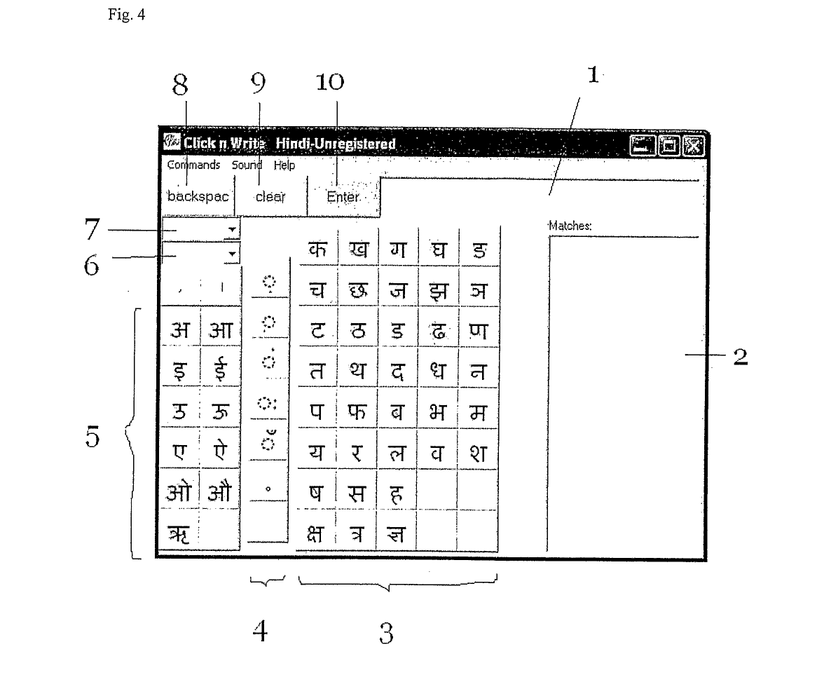

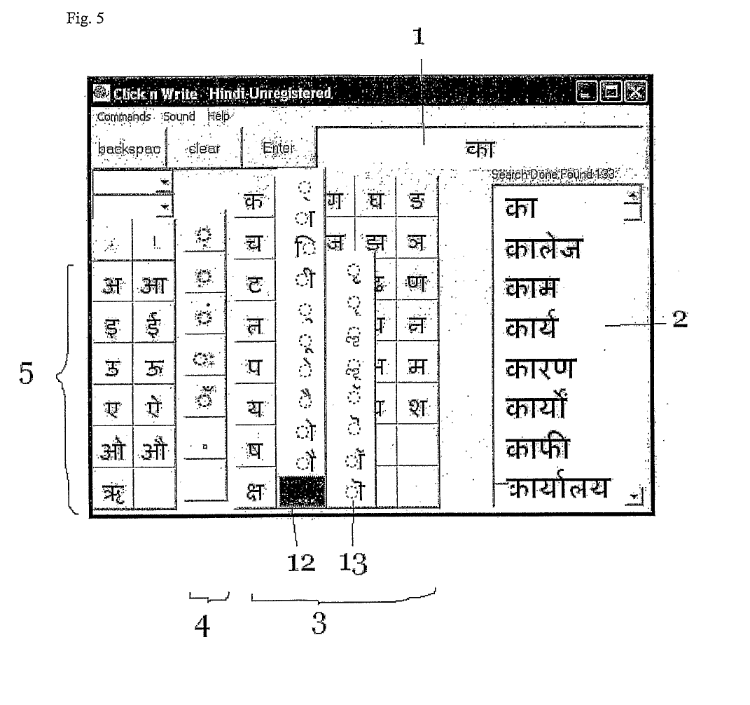

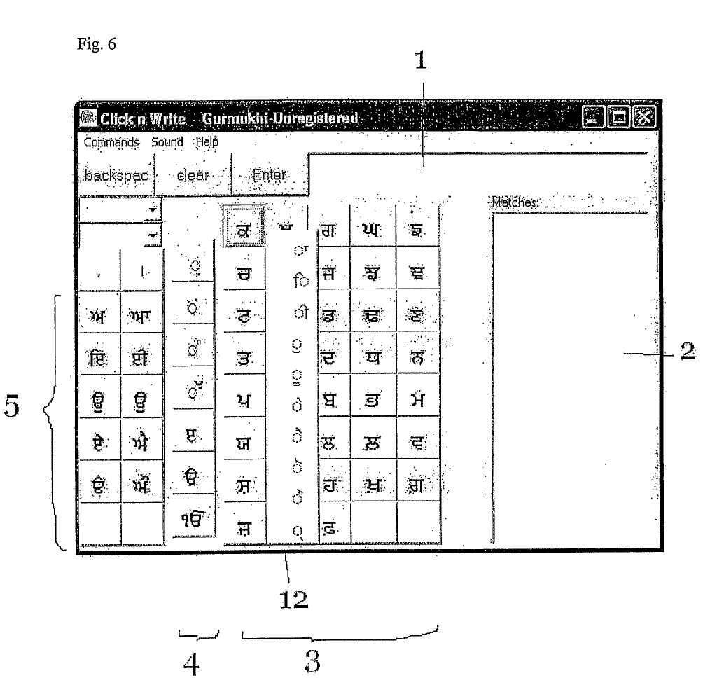

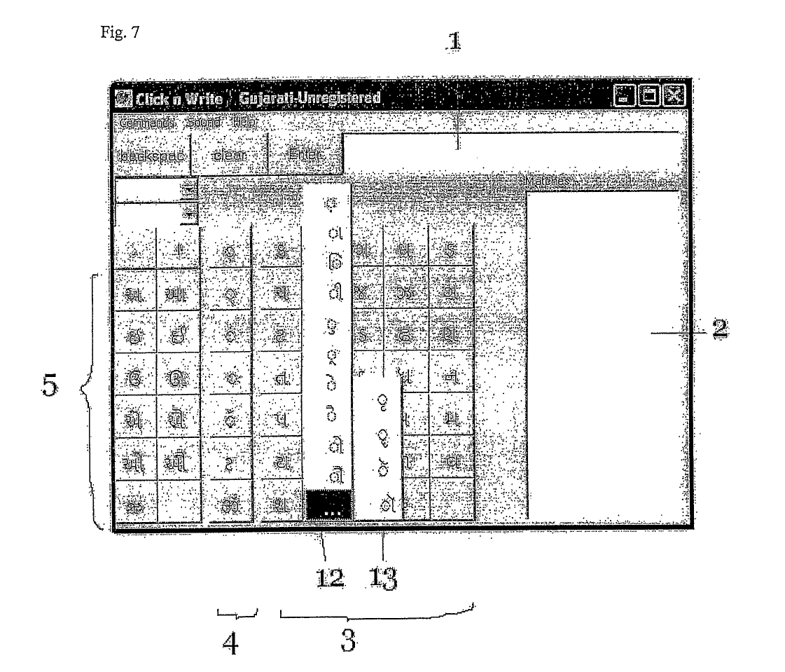

Furthermore, the embodiment may be adapted to different Indic languages. For example, FIGS. 4 and 5 show how the interface may appear in the case of Hindi. FIG. 4 shows a moment before any characters are entered, and FIG. 5 shows a moment corresponding to that of FIG. 2. FIGS. 6 and 7 show respectively the cases that the Indic language is Gurmukhi and Gujarati.

1. A computer system for input of Indic text, the computer system comprising a screen and a data entry device for screen-based data entry, the computer system being adapted to simultaneously run an Indic text entry program and application software adapted to receive Indic text, the computer system including a screen and a data entry device for screen-based data entry,
the Indic text entry program, when run by the computer system:
(i) generating a graphical user interface on the screen,
(ii) upon a user successively selecting Indic characters using the data input device and the graphical user interface, presenting the successively selected characters in a display area of the graphical user interface,
(iii) comparing the selected characters to a dictionary of items, and presenting to the user items from the dictionary are compatible with the selected characters;
(iv) upon the user selecting one of the presented items, registering the selection; and
(v) upon a command from the user, transferring the text to the application software.

2. A computer system according to claim 1 in which the graphical user interface presents the user with a number of first characters, the text entry program, upon selecting one of the first characters, presenting the user with one or more modifier characters compatible with the first character, and upon the user selecting one of the modifier characters, forming a combination of the first character with the modifier character.

3. A computer system according to claim 1 or claim 2 in which, when there are multiple items in the dictionary which are compatible with the selected characters, the text entry program presents only a selection of them to the user based on a frequency index associated with each item.

4. A computer system according to claim 3 which is operative to enable the user to vary the selection of compatible items.

5. A computer system according to claim 3 or claim 4 in which the text entry program orders the selected items according to the frequency index with the highest frequency words appearing at the top.

6. A computer system according to any preceding claim further including a keyboard for inputting additional text into the application software.

7. A computer system according to claim 6 in which the keyboard is a Roman alphabet keyboard.

8. A computer system according to any preceding claim in which the application software is one of Wordpad, Microsoft Word, Notepad, Yahoo chat, or Hotmail Messenger.

9. A Indic text entry program to be run on a computer system simultaneously with application software adapted to receive Indic text, the computer system including a screen and a data entry device for screen-based data entry,
the Indic text entry program when run by the computer system
(i) generating a graphical user interface on the screen,
(ii) upon a user successively selecting Indic characters using the data input device and the graphical user interface, presenting the successively selected characters in the graphical user interface, and
(iii) comparing the selected characters to a dictionary of items, and presenting to the user items from the dictionary are compatible with the selected characters;
(iv) upon the user selecting one of the presented items, registering the selection; and
(v) upon a command from the user, transferring the text to the application software.
